(19) United States
(12) Patent Application Publication
(10) Pub. No.: US 2026/0166833 A1
(43) Pub. Date: Jun. 18, 2026

(54) PRESS DIE CAPABLE OF SWITCHING BETWEEN SYMMETRICAL PROCESSING AND ONE-SIDED PROCESSING

(71) Applicants: HYUNDAI MOTOR COMPANY, Seoul (KR); Kia Corporation, Seoul (KR)

(72) Inventors: Sang Dong KIM, Hwaseong-si (KR); Gangyul Kim, Hwaseong-si (KR)

(21) Appl. No.: 19/209,210

(22) Filed: May 15, 2025

(30) Foreign Application Priority Data
Dec. 18, 2024 (KR) 10-2024-0190557

(51) Int. Cl. B30B 15/02; B30B 15/04

(52) U.S. Cl. CPC B30B 15/02; B30B 15/041

(57) ABSTRACT

A press die includes a lower die with a main molding surface having first and second molding surfaces that define two symmetrical product areas. A blank holder is arranged along an outer edge of the main molding surface and configured to hold a pair of blanks at a proper processing position. Additionally, a rising core is located at a center of the main molding surface between the two product areas. The rising core protrudes upward and is configured to assist in the molding process. The press die enables simultaneous production of symmetrical products as well as a one-sided mold processing.

### CROSS-REFERENCE TO RELATED APPLICATION(S)

This application is based on and claims priority to Korean Patent Application No. 10-2024-0190557, filed on Dec. 18, 2024, in the Korean Intellectual Property Office, the disclosure of which is herein incorporated by reference in its entirety.

### TECHNICAL FIELD

The present disclosure relates to a press die capable of switching between symmetrical processing and one-sided processing, and more particularly, to a press die capable of switching between symmetrical processing and one-sided processing, in which the press die is configured to obtain a high-quality processing result even if only one of the pair of products is manufactured through a die designed to manufacture a pair of products having symmetrical shapes that are different only in the horizontal or vertical direction, and to reduce generation of waste materials to be treated.

### BACKGROUND

A press forming process using a press die is implemented in various manners.

For example, the process of manufacturing a vehicle body panel may manufacture products having symmetrical shapes that are different only in the left and right directions, such as a left door panel and a right door panel.

In some cases, where it is advantageous to simultaneously manufacture, through press forming, products having shapes symmetrical to each other in the left-and-right direction or products each having a regular pattern, the products are manufactured through a molding surface formed to be symmetrical in the left-and-right direction.

In some cases, the molding surface, which is symmetrical in the left-and-right direction, may enable simultaneous manufacture of products each having a symmetrical structure in one cycle. In addition, in a press die, when a lower die and an upper die press each other in the upward-and-downward direction, it may be advantageous to manufacture products through the molding surface that is symmetrical in the left-and-right direction.

In some cases, the press die may have a horizontally symmetrical structure. When the molding surface is formed to be symmetrical, force applied by a press may be evenly distributed throughout the entire molding surface.

In actual product production sites, since a pair of products symmetrical to each other may not be always sold, only one of the pair of products may be produced.

In some cases, where a press forming process is performed in a state in which a material is placed on one side of the molding surface formed to produce products symmetrical to each other, pressure may not be uniformly applied to the material, which may have an adverse effect on a press die. Further, the degree of precision of the press die may deteriorate due to an asymmetrical load applied to the press die.

In some cases, products manufactured through one-sided molding may have a problem in that molding quality is low because the molding surface is not uniformly pressed and unintended pressure is applied to the molding surface.

In some cases, in order to produce products through one-sided molding, symmetrically formed molds are separated, or a new mold designed for a one-sided molding process may be manufactured. However, the these methods may not be economically efficient due to high investment costs for facilities, and a large space may be occupied for the process of the methods.

### SUMMARY

The present disclosure describes a press die that can prevent or reduce deterioration in quality of the produced product, when only one of the pair of products is produced through the press die designed to manufacture a pair of products symmetrical to each other.

The present disclosure describes a press die that can reduce the amount of materials to be used to produce only one of the pair of products through the press die designed to manufacture a pair of products symmetrical to each other. As a result, it can be possible to reduce the amount of materials discarded after the manufacturing process.

The present disclosure further describes a press die capable of producing both a pair of products symmetrical to each other and only one of the pair of products. In this manner, a press die designed to manufacture a pair of products symmetrical to each other can be used to manufacture only one of the pair of products.

According to one aspect of the subject matter described in this application, a press die is configured to perform a symmetrical mold processing and a one-sided mold processing. The press die includes a lower die having an upper surface that defines a main molding surface, the main molding surface being configured to form a pair of products that are symmetric in a left-and-right direction, the main molding surface including (i) a first molding surface being configured to form one of the pair of products, and (ii) a second molding surface being configured to form the other of the pair of products. The press die further includes a blank holder arranged along an outer circumference of the main molding surface of the lower die, the blank holder being configured to position a pair of blanks to a processing position at the lower die, and a rising core that is disposed at a central portion of the main molding surface between the first and second molding surfaces and protrudes upward from the main molding surface.

Implementations according to this aspect can include one or more of the following features. For example, the press die can further include an upper die positioned above the lower die and configured to move relative to the lower die in a vertical direction, the upper die having a lower surface that defines an upper molding surface facing the main molding surface of the lower die. In some examples, the upper die can be configured to, based on moving downward to the lower die, bring the upper molding surface into contact with the main molding surface of the lower die and apply vertical pressure to the main molding surface.

In some implementations, the upper die can be configured to move downward to press the lower die and to stop a downward movement based on a pressure applied to the upper die or the lower die being greater than a preset pressure value. In some examples, the upper die can be configured to move downward to press the lower die and to stop a downward movement based on a difference between a maximum pressure value and a minimum pressure value applied to the upper molding surface in the vertical direction exceeding a preset tolerance value.

In some implementations, the rising core can have a shape corresponding to a surface region located between the first molding surface and the second molding surface and is configured to extend upward from the main molding surface by a preset height. In some examples, the rising core can define at least two guide holes that each extend in a vertical direction, where the rising core includes a plurality of guide posts that are fixed to the lower die, each of the plurality of guide posts being inserted into a corresponding one of the at least two guide holes and configured to guide the rising core to move in the vertical direction.

In some implementations, the press die can further include at least one retainer bolt disposed at the rising core, the at least one retainer bolt having (i) a lower end fixed to the lower die and (ii) an upper end that extends into the rising core and is configured to restrict the rising core from rising above a preset maximum height with respect to the lower die. In some implementations, the press die can further include a rising pressure reduction module located at a lower portion of the rising core and configured to receive a vertical force applied to the rising core, where the rising pressure reduction module is configured to generate an upward reaction force of a preset magnitude in response to an external force that is applied to the rising core in a downward direction. For instance, the rising pressure reduction module includes a gas spring, a hydraulic spring, or a shock absorber.

In some examples, the rising pressure reduction module can be configured to, based on the external force being applied to the rising core in the downward direction, move the rising core in the downward direction to a preset position while maintaining the upward reaction force at the preset magnitude. In some implementations, the rising core can be made of spheroidal graphite cast iron.

In some implementations, the blank holder can be configured to, based on the press die performing the one-sided mold processing, hold a single blank configured to form one of the pair of products, the single blank being disposed at one of the first molding surface or the second molding surface and extending across the rising core to a middle portion of the other of the first molding surface or the second molding surface.

### BRIEF DESCRIPTION OF THE DRAWINGS

The above and other objects, features, and other advantages of the present disclosure will be more clearly understood from the following detailed description taken in conjunction with the accompanying drawings.

FIG. 1 is a schematic view showing an example of a pair blank to be input when a pair of products symmetrical to each other in the left-and-right direction are produced through a press die.

FIG. 2 is a perspective view showing an example of an upper die and a lower die in the press die.

FIG. 3 is a perspective view showing an example of a rising core provided at a central portion of a main molding surface in the press die.

FIG. 4 is a cross-sectional view showing an example of an internal structure of the rising core in the press die.

FIG. 5 is an exploded perspective view showing the internal structure of the rising core in the press die.

FIGS. 6 to 10 are schematic views each showing an example load applied to the main molding surface during press molding, where each of the schematic views shows a change in pressure applied to a single blank.

FIG. 11 is a view showing an example of a molding completion degree of one of the pair of products produced through the press die.

### DETAILED DESCRIPTION

Reference will now be made in detail to the one or more implementations of the present disclosure, examples of which are illustrated in the accompanying drawings. Wherever possible, the same reference numbers will be used throughout the drawings to refer to the same or like parts, and repetitive descriptions can be omitted. In the present application, a first direction (X-axis direction), a second direction (Y-axis direction), and a third direction (Z-axis direction) can be used to describe a three-dimensional shape in a three-dimensional space, and the respective directions are orthogonal to each other.

The present disclosure relates to a press die 100 capable of switching between a symmetrical mold processing and a one-sided mold processing. For example, the press die 100 can be configured to simultaneously manufacture a pair of products symmetrical to each other in the left-and-right direction, and, in some cases, to manufacture only one of the pair of products individually.

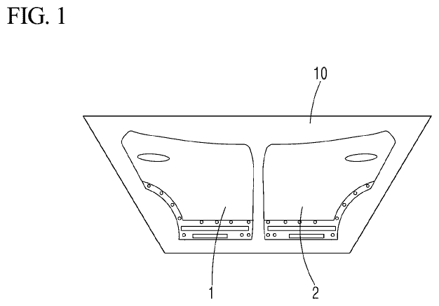

FIG. 1 is a schematic view showing a pair blank 10 to be input when a pair of products symmetrical to each other in the left-and-right direction are produced through the press die 100 and a symmetrical pair of products to be produced.

The press die 100 can produce a pair of products symmetrical to each other in the left-and-right direction. As shown in FIG. 1, in the process of manufacturing a panel of a vehicle, there are many vehicle parts provided in pair and formed to have the same shape. However, the pair of vehicle parts can have a different shape in the left-and-right direction. Examples of the pair of vehicle parts having a different shape in the left-and-right direction include left and right doors and left and right fenders.

In some examples, a die can be manufactured to simultaneously produce each pair of the above-described products.

For example, as shown in FIG. 1, when a main molding surface 300 is manufactured for a pair of left and right products, the pair blank 10 can be placed on the main molding surface 300 of a lower die 200 with a width allowing a pair of products to be simultaneously molded. The pair blank 10 disposed on the upper portion of the main molding surface 300 or a single blank 12 to be described later is a material to manufacture a product, and the pair blank 10 or the single blank 12 can be accurately seated at a predetermined position by a blank holder 330 formed on the lower die 200.

In some implementations, when symmetrical processing is performed according to the main purpose of the press die 100, it is possible to simultaneously manufacture a first pair product 1 and a second pair product 2 that are formed to be symmetrical to each other in the left-and-right direction by using the pair blank 10 having an appropriate size.

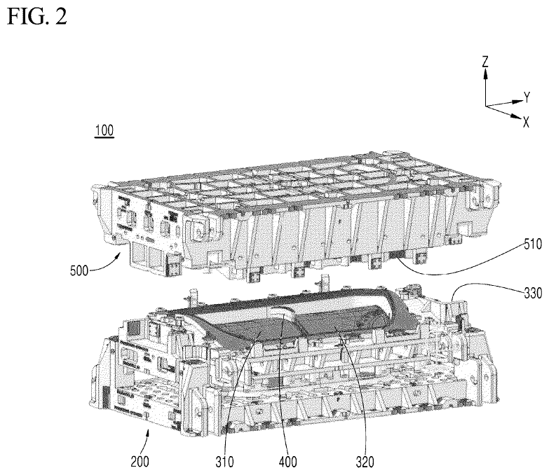

FIG. 2 is a perspective view of an upper die 500 and the lower die 200 in the press die 100.

As shown in FIG. 2, the press die 100 includes the lower die 200 and the upper die 500.

First, the lower die 200 is a basic structure of the press die 100 and includes the main molding surface 300 serving as a molding surface and the blank holder 330 arranged around the main molding surface.

The main molding surface 300 is formed on the upper surface of the lower die 200. The main molding surface 300 is formed to be able to simultaneously mold products having symmetrical shapes in the left-and-right direction.

The main molding surface 300 can include a first molding surface 310 and a second molding surface 320. Here, the first molding surface 310 is provided to mold one of the products having symmetrical shapes in the left-and-right direction.

The second molding surface 320 is provided to mold the other of the products having symmetrical shapes in the left-and-right direction.

In some implementations, a rising core 400 is disposed on the center of the main molding surface 300 and plays an important role during a one-sided molding process.

The blank holder 330 can be installed around the outer side of the main molding surface 300 of the lower die 200. The blank holder 330 stably fixes the inserted pair blank 10 or the single blank 12 to a predetermined processing position.

In some implementations, the blank holder 330 also has an effect of preventing movement of the pair blank 10 or the single blank 12 during the molding process of the product.

In some examples, the blank holder 330 can be configured to, based on the press die 100 performing the one-sided mold processing, hold the single blank 12 configured to form one of the pair of products, where the single blank 12 is disposed at one of the first molding surface 310 or the second molding surface 320 and extends across the rising core 400 to a middle portion of the other of the first molding surface 310 or the second molding surface 320.

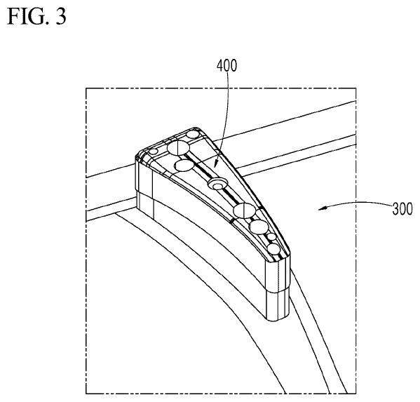

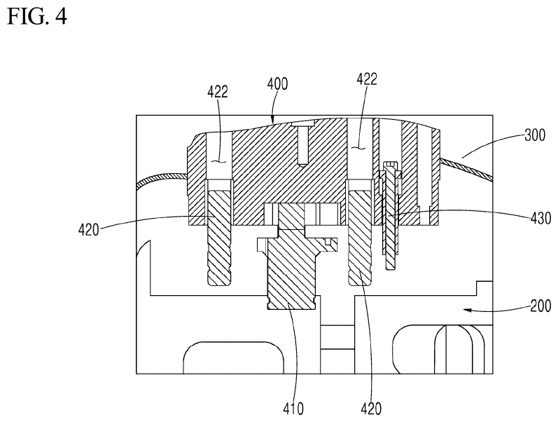

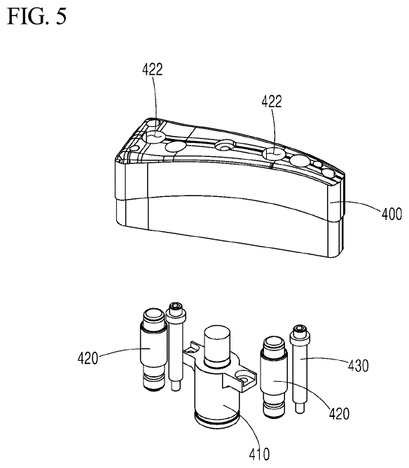

FIG. 3 is a perspective view of the rising core 400 provided at the central portion of the main molding surface 300 in the press die 100, FIG. 4 is a cross-sectional view of an internal structure of the rising core 400 in the press die 100, and FIG. 5 is an exploded perspective view of the internal structure of the rising core 400 in the press die 100.

As shown in FIGS. 3 to 5, the rising core 400 is provided at the central portion of the main molding surface 300 of the lower die 200. The rising core 400 is formed to protrude upwards from the main molding surface 300.

The rising core 400 prevents, when only one of the pair of products is produced, deterioration in quality of the produced product and serves to uniformly apply pressure to the product to be produced during the molding process.

The rising core 400 is disposed between the first molding surface 310 and the second molding surface 320. The rising core 400 can be formed to have an appropriate shape depending on a space formed between the first molding surface 310 and the second molding surface 320.

The rising core 400 is a single mass structure made of spheroidal graphite cast iron, and a plurality of guide holes 422 can be formed in a vertical linear direction.

Each of the guide holes 422 serves as a passage formed by vertically drilling a body portion of the rising core 400 in a straight line.

A plurality of guide holes 422 can be provided, and each of the guide holes 422 can accommodate a guide post 420 therein.

The guide post 420 has a lower end fixed to the lower die 200. At least a part of the upper end of the guide post 420 enters a lower entrance of the guide hole 422 and is accommodated therein in the longitudinal direction of the guide hole 422.

Each of the guide posts 420 can be formed as a straight column in the vertical direction, and the guide posts 420 are respectively inserted into the guide holes 422, thereby making it possible to guide and move the rising core 400 upwards and downwards in the vertical direction.

A retainer bolt 430 can be inserted into and coupled to the inner space of the rising core 400, and the lower portion of the retainer bolt 430 can be fixed to the lower die 200.

A plurality of retainer bolts 430 can be provided and can be accommodated in the space formed inside the rising core 400, thereby preventing the rising core 400 from rising above a predetermined height.

A rising pressure reduction module 410 can be installed at the lower portion of the rising core 400 and can induce the rising core 400 to perform a predetermined reaction according to external force applied to the rising core 400 in the vertical direction between the rising core 400 and the lower die 200.

Specifically, the rising pressure reduction module 410 can be provided in the form of a gas spring, a hydraulic spring, or a shock absorber.

The rising pressure reduction module 410 receives external force applied to the rising core 400, especially pressure applied to the lower portion of the rising core 400 in the vertical direction. Further, the rising pressure reduction module 410 applies appropriate upward reaction force to the single blank 12 when only one of the pair of products is processed.

The rising core 400 can detect the location of pressure applied to the main molding surface 300. When external force detected through the main molding surface 300 is greater than a predetermined value, the rising core 400 is smoothly moved downwards by a predetermined length.

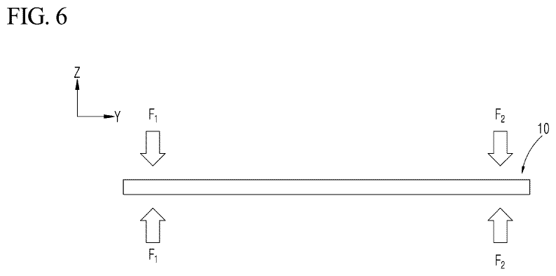

FIGS. 6 to 10 are schematic views each showing a load applied to the main molding surface 300 during press molding in an easy-to-understand manner, in which each of the schematic views shows a change in pressure applied to the single blank 12 for each case.

As shown in FIGS. 6 to 10, when the press die 100 is set in a symmetrical processing state, the upper die 500 is moved downwards, and pressure applied to the lower die 200 is distributed evenly to the left and right sides of the lower die.

The upper die 500 is positioned vertically above the lower die 200, and the main molding surface 300 of the lower die 200 is pressed by the upper die 500 during the molding process, thereby producing a product having a predetermined shape.

An upper molding surface 510 is formed on the lower surface of the upper die 500, in which the upper molding surface faces the main molding surface 300 of the lower die 200.

The upper molding surface 510 is engaged with the lower main molding surface 300, thereby uniformly applying vertical pressure to the pair blank 10 or the single blank 12 interposed between the upper molding surface 510 and the lower main molding surface 300.

In the case of symmetrical molding, the entire surface on which the main molding surface 300 is formed is covered by the pair blank 10 and is fixed by the blank holder 330. Accordingly, vertical pressure is uniformly applied to the entire main molding surface 300 as designed when the upper die 500 is moved downwards.

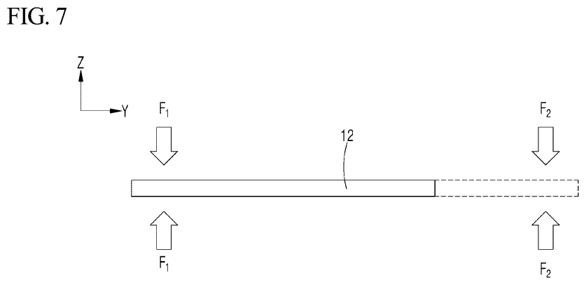

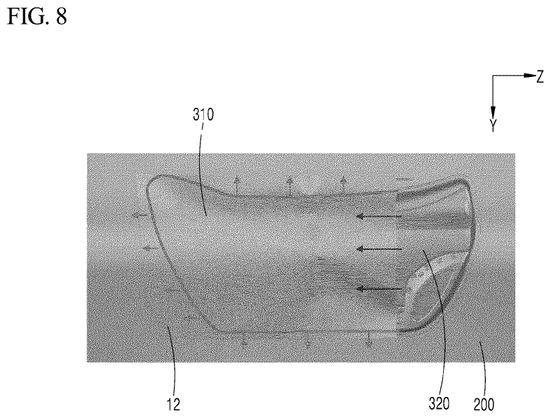

In some examples, as shown in FIGS. 7 and 8, in order to process only one of the pair of products, when the single blank 12 having a small area is placed on the main molding surface 300, the upper die 500 presses the lower main molding surface 300 with the same force along the same path as in the case of symmetrical processing.

In some examples, the single blank 12 that is inserted between the upper molding surface 510 and the lower main molding surface 300 so as to manufacture only one of the pair of products does not cover the entire main molding surface 300. In this case, the vertical pressure of a space in which the single blank 12 is not placed acts to push or pull the single blank 12 being processed from one side so as to maintain the balance of force around the single blank.

Therefore, the single blank 12 that is inserted between the upper molding surface 510 and the lower main molding surface 300 so as to manufacture only one of the pair of products may not receive vertical pressure to be applied thereto for the appropriate molding process on the main molding surface or can receive excessive pressure, which can cause deterioration in quality of the produced one of the pair of the products.

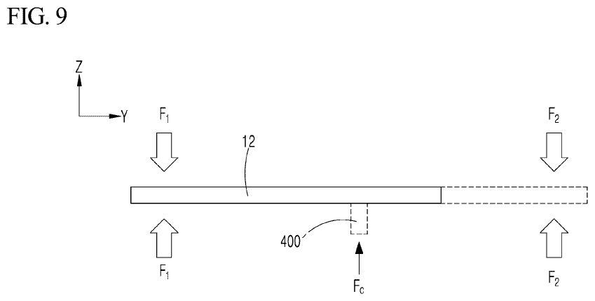

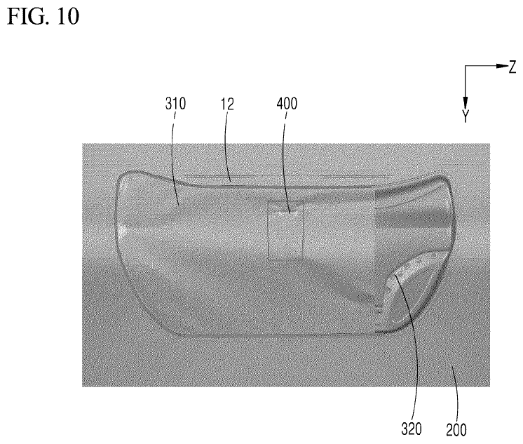

As shown in FIGS. 9 and 10, when one-sided molding is performed to manufacture only one of the pair of products, the rising core 400 formed on the main molding surface 300 in the press die 100 can be appropriately used.

As shown in the drawing, in order to manufacture only the product corresponding to the first molding surface 310, the rising core 400 applies a predetermined upward reaction force from below to the single blank 12 through the rising pressure reduction module 410.

In some cases, where the rising core 400 is not installed, values of upward pressure and downward pressure applied to the left and right sides of the main molding surface 300 significantly vary depending on the location of the main molding surface 300. In some implementations, in the operation of the present disclosure, the rising core 400 can provide a predetermined upward reaction force from the central portion of the main molding surface 300 and can be moved downwards or upwards again by a predetermined length depending on the magnitude of force vertically applied to the main molding surface. In this manner, even if the single blank 12 installed on the main molding surface 300 does not cover the entire area of the main molding surface 300, upward external force transmitted to the single blank 12 can be evenly distributed throughout the entire main molding surface 300.

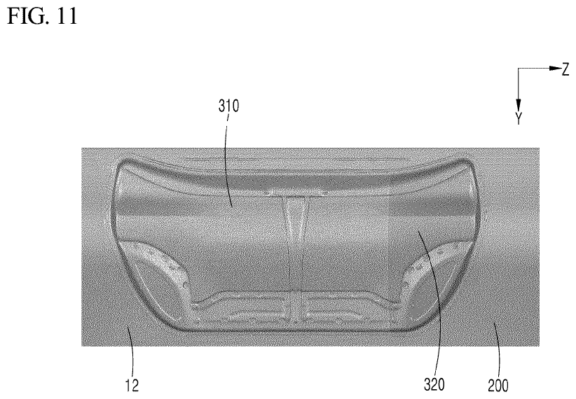

FIG. 11 is a view showing a molding completion degree of one of the pair of products produced through the press die 100.

As shown in FIG. 11, when only one of the pair of products is manufactured through the molding process of the single blank 12 having a small size, the rising core 400 made of spheroidal graphite cast iron appropriately applies upward reaction force from below to the single blank 12, thereby making it possible to produce a product having excellent quality through one-sided processing.

In some examples, the upper die 500 is moved downwards so as to press the lower die 200. Here, when pressure higher than a predetermined pressure is detected, downward movement of the upper die 500 can be stopped. For example, the press die can include one or more sensors configured to detect the pressure applied to the upper die or the lower die.

In some implementations, when a difference between the maximum and minimum values of vertical pressure applied to the upper molding surface 510 or the main molding surface 300 is measured to be greater than a predetermined tolerance value, it is determined product processing is not properly performed. In this case, downward movement of the upper die 500 can be stopped, and the state of the press die 100 can be reset to an initial condition.

As is apparent from the above description, the present disclosure provides the following effects.

The present disclosure has an effect of selectively manufacturing only one of the pair of products through a press die designed to manufacture a pair of products symmetrical to each other, and improving the quality of the manufactured one of the pair of products symmetrical to each other.

According to the present disclosure, when only one of the pair of products is manufactured through a die designed to manufacture a pair of products symmetrical to each other, there is an advantage in that an amount of material may be reduced to manufacture the product.

The present disclosure has an effect of reducing waste materials to be generated when a large amount of material is used to manufacture only one of the pair of products.

The present disclosure has an effect of manufacturing only one of the pair of products with reliable quality through the molding surface of a die designed to manufacture a pair of products symmetrical to each other.

The effects of the present disclosure are not limited to the above-mentioned effects, and other effects not mentioned herein will be clearly understood by those skilled in the art from the detailed description of the implementations.

Implementations of the present disclosure have been described in detail with reference to the accompanying drawings. It is obvious that the implementations and drawings are merely illustrative. Further, it will be appreciated by those skilled in the art that various modifications and improvements can be made in the implementations without departing from the principles and spirit of the disclosure, the scope of which is defined in the appended claims and equivalents thereto.

The implementations should be considered as a part of the present disclosure, and the scope of the present disclosure is not limited to the implementations.

The scope of the present disclosure should be determined in accordance with the technical idea described in the claims.

In addition, even if the action or effect of a specific configuration in the described implementations are not explicitly described, action or effect predictable from a corresponding configuration is included in the scope of the present disclosure.

What is claimed is:

1. A press die configured to perform a symmetrical molding process and a one-sided molding process, the press die comprising:
a lower die having an upper surface that defines a main molding surface, the main molding surface being configured to form a pair of products that are symmetric in a left-and- right direction, the main molding surface comprising (i) a first molding surface being configured to form one of the pair of products, and (ii) a second molding surface being configured to form the other of the pair of products;
a blank holder arranged along an outer circumference of the main molding surface of the lower die, the blank holder being configured to position a pair of blanks to a processing position at the lower die; and
a rising core that is disposed at a central portion of the main molding surface between the first and second molding surfaces and protrudes upward from the main molding surface.

2. The press die of claim 1, further comprising an upper die positioned above the lower die and configured to move relative to the lower die in a vertical direction, the upper die having a lower surface that defines an upper molding surface facing the main molding surface of the lower die.

3. The press die of claim 2, wherein the upper die is configured to, based on moving downward to the lower die, bring the upper molding surface into contact with the main molding surface of the lower die and apply vertical pressure to the main molding surface.

4. The press die of claim 3, wherein the upper die is configured to move downward to press the lower die and to stop a downward movement based on a pressure applied to the upper die or the lower die being greater than a preset pressure value.

5. The press die of claim 3, wherein the upper die is configured to move downward to press the lower die and to stop a downward movement based on a difference between a maximum pressure value and a minimum pressure value applied to the upper molding surface in the vertical direction exceeding a preset tolerance value.

6. The press die of claim 1, wherein the rising core has a shape corresponding to a surface region located between the first molding surface and the second molding surface and is configured to extend upward from the main molding surface by a preset height.

7. The press die of claim 6, wherein the rising core defines at least two guide holes that each extend in a vertical direction, and
wherein the rising core comprises a plurality of guide posts that are fixed to the lower die, each of the plurality of guide posts being inserted into a corresponding one of the at least two guide holes and configured to guide the rising core to move in the vertical direction.

8. The press die of claim 7, further comprising at least one retainer bolt disposed at the rising core, the at least one retainer bolt having (i) a lower end fixed to the lower die and (ii) an upper end that extends into the rising core and is configured to restrict the rising core from rising above a preset maximum height with respect to the lower die.

9. The press die of claim 7, further comprising a rising pressure reduction module located at a lower portion of the rising core and configured to receive a vertical force applied to the rising core,
wherein the rising pressure reduction module is configured to generate an upward reaction force of a preset magnitude in response to an external force that is applied to the rising core in a downward direction.

10. The press die of claim 9, wherein the rising pressure reduction module comprises a gas spring, a hydraulic spring, or a shock absorber.

11. The press die of claim 9, wherein the rising pressure reduction module is configured to, based on the external force being applied to the rising core in the downward direction, move the rising core in the downward direction to a preset position while maintaining the upward reaction force at the preset magnitude.

12. The press die of claim 1, wherein the rising core is made of spheroidal graphite cast iron.

13. The press die of claim 1, wherein the blank holder is configured to, based on the press die performing the one-sided molding process, hold a single blank configured to form one of the pair of products, the single blank being disposed at one of the first molding surface or the second molding surface and extending across the rising core to a middle portion of the other of the first molding surface or the second molding surface.
